(19) United States
(12) Patent Application Publication
(10) Pub. No.: US 2004/0242763 A1
(43) Pub. Date: Dec. 2, 2004

(54) Radiation-curable polyurethane dispersion

(76) Inventors: Michel Tielemans, Wemmel (BE); Dirk Bontinck, Ertvelde (BE); Vincent Renard, Couthuin (Heron) (BE)

Correspondence Address: WENDEROTH, LIND & PONACK, L.L.P., 2033 K STREET N. W., SUITE 800, WASHINGTON, DC, 20006-1021, US

(21) Appl. No.: 10/491,166

(22) PCT Filed: Nov. 27, 2001
(86) PCT No.: PCT/EP02/13685

(30) Foreign Application Priority Data
Nov. 28, 2001 (EP) 01128234.0

(51) Int. Cl. C08K 3/00

(52) U.S. Cl. 524/589; 524/839

(57) ABSTRACT

The invention relates to new radiation-curable composition comprising an aqueous dispersion containing an unsaturated polyurethane with repeating units of tetramethylxylylene diisocyanate as the essential diisocyanate compound. The invention also relates to a process for making these dispersions in the absence of solvents. The product and process can meat severe environmental requirements in terms of absence of solvents, absence of amines and absence of irritating materials. The coatings obtained from the dispersions of the invention have all together a good resistance combined with a good cold flexibility. In particular, the coatings are glossy and exhibit a high adhesion, a good chemical resistance to stain, water and solvent and a good mechanical resistance to scratch and abrasion.

The present invention relates to a new radiation-curable composition comprising an aqueous dispersion containing an unsaturated polyurethane with repeating units of tetramethylxylylene diisocyanate (hereafter referred to as TMXI) as the essential diisocyanate compound. The invention also relates to a process for making these dispersions especially in the absence of any solvent. Finally, the invention relates to a new radiation-curable composition comprising an unsaturated polyurethane with repeating units of tetramethylxylylene diisocyanate (hereafter referred to as TMXI) as the essential diisocyanate compound.

Polyurethane dispersions (PUD) are produced in the form of a stable dispersion in water of very small polyurethane polymer particles whose size ranges from 20 to 200 nm. These products are allowed to form a continuous film upon drying of the water during a complex process involving the coalescence of the individual particles through the effect of capillary forces.

Polyurethane dispersions find an increasingly important position in the market place because they offer top performance while contributing at the same time to reduce the volatile organic content (VOC). As a consequence, they find a growing interest in the industry to fulfil any high demanding coating application on any sort of substrate.

Polyurethane dispersions curable by irradiation are known in the art. Those curable by ultraviolet irradiation or electron beam (UV-PUD) are especially suitable for obtaining the highest performance because of their high crosslinking density after cure. Polyurethane dispersions curable by irradiation are usually water-based products with a low volatile organic content (VOC) and a low viscosity for application. They form a tack-free coating before cure, that becomes a hard but flexible coating with an excellent resistance after cure. Such type of compositions is disclosed, for example, in U.S. Pat. No. 5,290,663, U.S. Pat. No. 4,153,778, EP 181.486 and EP 704.469 patents. They are alternatives to the conventional radiation curable compositions containing neither solvent nor water.

The synthesis of polyurethane polymers in the absence of solvents can be restricted by the rapid obtention of extremely high viscosity as a result of the molecular weight increase. Polyurethanes based on TMXI provide significantly lower viscosity than other polyurethane polymers.

The property of TMXI to make it possible to synthesise polyurethane water dispersions without the use of solvents is described, for example, in the reference article “Unique Waterborne Systems Based on TMXI aliphatic isocyanate”, R. D. Cody, Progress in

Organic coatings, 22, 107-123 (1993). Another similar reference is “New and Improved Waterborne Polyurethanes from the TMXI Aliphatic Isocyanate Family”, R. D. Cody and V. S. Askew, presentation at the Waterborne and Higher Solids Coatings Symposium, February 21-23, New Orleans, USA, 1990.

The above-mentioned article published in “Progress in Organic Coatings” states that “Poly(urethane) dispersions are fully reacted, high molecular weight poly(urethane)-poly(urea) polymers dispersed in water.” (page 109, lines 11-12). Thus these TMXI-PUD polymers are not further curable (crosslinkable).

Moreover, such TMXI-PUD polymers do not always give the most satisfactory results in terms of properties of the obtained product, particularly concerning product resistance. This is assessed in the following description by comparing double rubs resistance test results of example 1, made according to the present invention, with comparative example 11, which is a conventional fully reacted TMXI-PUD polymer.

An object of the present invention is to provide a polyurethane dispersion having a high performance profile after cure, together with a low volatile organic content (VOC) and a high process productivity in terms of absence of solvent and hence of stripping operation under vacuum.

Polyurethane dispersions are generally produced by first preparing a polyurethane prepolymer made by reacting polyisocyanates with organic compounds containing at least two reactive groups which can react with isocyanates, generally polyols. The reaction is usually catalysed and carried out at moderate temperature in the presence of a solvent. The prepolymer generated with an excess of polyisocyanate contains free isocyanate end-groups which are then capped (or chain extended) by any well known agent used to inactivate the terminal isocyanate groups, for instance those that contain ethylenically unsaturated functions. The dispersion process of the polyurethane prepolymer usually requires the neutralization of the prepolymer to its anionic salt form before or during the high shear dispersion in water. Preferably, the polyurethane prepolymer is added to the water under vigorous agitation or, alternatively, water may be stirred into the prepolymer. The solvent is removed during a complementary stripping operation under vacuum.

It has now surprisingly be found that it is possible to prepare unsaturated polyurethane dispersions containing TMXI, in the absence of any solvent. It has been observed that no gelification or polymerisation occurs during the step of end-capping the first prepared polyurethane prepolymer with the compound comprising unsaturations, as one could have taught, and that the viscosity of the reaction mixture remains relatively low. No solvent striping step is needed in these conditions, and the obtained dispersion is extremely low in volatile organic compounds (VOC). Moreover, the neutralization of the reaction mixture needed to make the dispersion can be done by inorganic bases without problems of pH control or dispersion stability, which make it possible to reject amines and, consequently, to avoid bad smells and possible health injuries. Furthermore, in properly selecting the unsaturated end-capping compound, it is also possible to obtain non-irritating dispersions, also called “Xi-free dispersions”.

The dispersions of the invention have a high dry content, a low viscosity, an excellent stability, a low particle size and a good film formation.

The coatings obtained from the dispersions of the invention have all together a good cold flexibility and a good resistance. The coatings have a good chemical resistance against stains, water & solvent, and have a good mechanical resistance against scratch and abrasion while being flexible at ambient or low temperature. They exhibit a superior adhesion on the substrate. The good optical properties care for high transparency and gloss.

Thus the invention provides a radiation-curable composition which comprises an aqueous dispersion containing at least one ethylenically unsaturated polyurethane polymer which is formed from a polyurethane prepolymer (A) prepared from:

(i) at least one diisocyanate compound containing tetramethylxylylene diisocyanate as the major component,

(ii) at least one organic compound containing at least two reactive groups which can react with isocyanate groups, and

(iii) at least one hydrophilic compound, which is capable to render the polyurethane polymer dispersible in aqueous medium, and the polyurethane prepolymer (A) is reacted with:

(iv) at least one unsaturated compound containing at least one reactive group which can react with isocyanate groups, and at least one ethylenic unsaturation,

to form an ethylenically unsaturated, radiation-curable polyurethane polymer (B).

The invention also provides a process for the preparation of a radiation-curable composition which comprises a polyurethane-containing dispersion, which process comprises:

(A) forming a polyurethane prepolymer by reacting:

(i) at least one diisocyanate compound containing tetramethylxylylene diisocyanate as the major component,

(ii) at least one organic compound containing at least two reactive groups which can react with isocyanates groups,

(iii) at least one hydrophilic compound ensuring water dispersibility of the polymer

(B) forming a polyurethane polymer containing radiation-curable ethylenic unsaturations by reacting the polyurethane prepolymer with:

(iv) at least one unsaturated compound containing at least one reactive group which can react with isocyanate groups and at least one ethylenic unsaturation able to provide radiation-curability of the polymer,

(C) dispersing a composition comprising the polyurethane polymer in an aqueous medium, and optionally reacting the polyurethane polymer with at least one neutralizing agent before or during the dispersion in water and capable to provide an ionic salt of compound (iii).

In another embodiment, the compound (iii) is neutralised to its ionic salt prior to its incorporation in the polyurethane prepolymer.

The composition and process according to the present invention are advantageous in that they provide:

1) a high performance profile after radiation curing in terms of gloss, adhesion, stain resistance, water- and solvent-resistance, scratch- and abrasion-resistance, and low-temperature flexibility.

2) an attractive process in terms of productivity, since there is no additional solvent stripping step as described in the state of the art.

3) an environment-friendly compliance in terms of absence of solvents, absence of amines and absence of irritating materials. The “green” aspect of a product is becoming an essential added-value today in the market. Solvents are contributing to increase the volatile organic content (VOC), and amines generate a bad odour perception in the coating area and subsequent health injuries. Skin irritation problems limit the safe handling of the product and impose the use of a special labelling (Xi) which makes the product less attractive for the user.

4) A large scope of polymer characteristics in terms of mechanical properties (harder and softer) and hydrophilicity (more hydrophilic or hydrophobic). This wide spectrum allows to cover many different application areas as, for example, coatings for resilient flooring, wood, plastic, glass, metal, automotive, concrete, print receptive coatings, overprint varnishes, ink binders, inkjet.

The advantages provided by the invention are believed to be unexpected on the following points:

It is not immediate to derivatise a known TMXI-PUD polymer into a radiation-curable-TMXI-PUD as this implies a major change of polymer composition, process and curing/application leading to another type of product with a dramatic modification of properties and performance after cure compared with the parent product.

It is unexpected that the final polymer dispersion in water presents a set of favourable characteristics such as high dry content, low viscosity, low particle size, excellent stability and easy film formation.

It is unexpected that the radiation-curable-TMXI-PUDs offer a combination of antagonistic performance such as: improved resistance and cold flexibility on a flexible substrate.

It is unexpected that the reaction process can take place without any solvent without giving rise to extreme viscosity or gelification, particularly during the second step when reactive double bounds are present

It is highly surprising to experimentally observe a gelification of the polymer when the reaction process takes place in a solvent like acetone or N-methylpyrrolidone, and despite the fact that the presence of solvents is naturally perceived as favourable to prevent any gelification effect due to higher dilution.

It is unexpected that the process can accommodate so easily a soda neutralisation instead of an amine neutralization without generating reactor fouling after dispersion; often, with other polymers/process, problems of pH and stability of the dispersion are observed with inorganic bases, leading to premature hydrolysis and/or change of coloration of the polymer at higher pH.

It is unexpected that the environmental benefits offered by no solvent (VOC), no amine (odour) and no irritancy health) can all be combined in one single product having a good performance and a productivity benefit on top (no solvent stripping).

Finally, the invention relates to a radiation-curable composition which comprises at least one ethylenically unsaturated polyurethane polymer which is formed from a polyurethane prepolymer (A′) prepared from:

i) at least one diisocyanate compound containing tetramethylxylylene diisocyanate as the major component,

ii) at least one organic compound containing at least two reactive groups which can react with isocyanate groups, and the polyurethane prepolymer (A′) is reacted with:

iii) at least one unsaturated compound containg at least one reactive group which can react with isocyanate groups, and at least one ethylenic unsaturation, to form an ethylenically unsaturated, radiation-curable polyurethane polymer (B′).

Preferred embodiments of the invention are mentioned below.

Tetramethylxylylene disisocyanate (compound i) is of formula: OCN—C(CH3)2-C6H4-C(CH3)2-NCO. The respective positions of the isocyanate substituants on the benzenic cycle can thus be ortho, meta or para. The meta version is preferred because of its commercial availability. The amount of tetramethylxylylene diisocyanate in compound (i) preferably ranges from 50 to 100%, more preferably 80 to 100% and most preferably 95 to 100% w/w.

The organic compounds containing at least two reactive groups which can react with isocyanates (compound ii) are preferably polyols, but e.g. amines can also be used.

Suitable examples are polyester polyols, polyether polyols, polycarbonate polyols, polyacetal polyols, polyesteramide polyols, polyacrylate polyols, polythioether polyols and combinations thereof. Preferred are the polyester polyols, polyether polyols and polycarbonate polyols. These organic compounds containing at least two reactive groups which are enabled to react with isocyanates, preferably have a number average molecular weight within the range of 400 to 5,000.

Polyester polyols are particularly preferred and suitable polyester polyols which may be used comprise the hydroxyl-terminated reaction products of polyhydric, preferably dihydric alcohols (to which trihydric alcohols may be added) with polycarboxylic, preferably dicarboxylic acids or their corresponding carboxylic acid anhydrides. Polyester polyols obtained by the ring opening polymerization of lactones may also be used.

The polycarboxylic acids which may be used for the formation of these polyester polyols may be aliphatic, cycloaliphatic, aromatic and/or heterocyclic and they may be substituted (e.g. by halogen atoms) and saturated or unsaturated. As examples of aliphatic dicarboxylic acids, there may be mentioned, succinic acid, glutaric acid, adipic acid, suberic acid, azelaic acid, sebacic acid and dodecanedicarboxylic acid. As an example of a cycloaliphatic dicarboxylic acid, there may be mentioned hexahydrophthalic acid. Examples of aromatic dicarboxylic acids include isophthalic acid, terephthalic acid, ortho-phthalic acid, tetrachlorophthalic acids and 1,5-naphthalenedicarboxylic acid. Among the unsaturated aliphatic dicarboxylic acids which may be used, there may be mentioned fumaric acid, maleic acid, itaconic acid, citraconic acid, mesaconic acid and tetrahydrophthalic acid. Examples of tri- and tetracarboxylic acids include trimellitic acid, trimesic acid and pyromellitic acid.

The polyhydric alcohols which are preferably used for the preparation of the polyester polyols include ethylene glycol, propylene glycol, 1,3-propanediol, 1,3-butanediol, 1,4-butanediol, 1,5-pentanediol, 1,6-hexanediol, neopentyl glycol, diethylene glycol, dipropylene glycol, triethylene glycol, tetraethylene glycol, dibutylene glycol, 2-methyl-1,3-pentanediol, 2,2,4-trimethyl-1,3-pentanediol, 1,4-cyclohexanedimethanol, ethylene oxide adducts or propylene oxide adducts of bisphenol A or hydrogenated bisphenol A. Triols or tetraols such as trimethylolethane, trimethylolpropane, glycerin and pentaerythritol may also be used. These polyhydric alcohols are generally used to prepare the polyester polyols by polycondensation with the above-mentioned polycarboxylic acids, but according to a particular embodiment they can also be added as such to the polyurethane prepolymer reaction mixture.

Suitable polyether polyols comprise polyethylene glycols, polypropylene glycols and polytetramethylene glycols, or bloc copolymers theirof.

Suitable polycarbonate polyols which may be used include the reaction products of diols such as 1,3-propanediol, 1,4-butanediol, 1,6-hexanediol, diethylene glycol, triethylene glycol or tetraethylene glycol with phosgene, with diarylcarbonates such as diphenylcarbonate or with cyclic carbonates such as ethylene and/or propylene carbonate.

Suitable polyacetal polyols which may be used include those prepared by reacting glycols such as diethyleneglycol with formaldehyde. Suitable polyacetals may also be prepared by polymerizing cyclic acetals.

The total amount of these organic compounds containing at least two reactive groups which can react with isocyanates preferably ranges from 30 to 90 wt % of the polyurethane prepolymer, more preferably of from 40 to 60 wt %.

Preferably, compound (ii) is a polyol compound, preferably a polyester polyol, more preferably a polyester polyol made from the polycondensation of neopentylglycol and adipic acid and having a molecular weight not higher than 5000. The polyester polyol may also contain an air-drying component such as a long chain unsaturated fatty acid.

The hydrophilic compound (iii) which is capable to react with (i) or (ii) is preferably a polyol having an incorporated or pendant functionality that can exhibit an ionic or non-ionic hydrophilic nature, and more preferably a polyol containing anionic salt groups (or acid groups which may be subsequently converted to such anionic salt groups) like carboxylate or sulfonate salt groups (or the carboxylic or sulfonic acids which may be converted into such carboxylate or sulfonate salt groups). The compound (iii) is necessary to render the polyurethane prepolymer self-dispersible in water.

The carboxylate salt groups incorporated into the isocyanate-terminated polyurethane prepolymers generally are derived from hydroxycarboxylic acids represented by the general formula (HO)ₓR(COOH)_{y}, wherein R represents a straight or branched hydrocarbon residue having 1 to 12 carbon atoms, and x and y independently are integers from 1 to 3. Examples of these hydroxycarboxylic acids include citric acid and tartaric acid. The most preferred hydroxycarboxylic acids are the α,α-dimethylolalkanoic acids, wherein x=2 and y=1 in the above general formula, such as for example, the 2,2-dimethylolpropionic acid. The pendant anionic salt group content of the polyurethane polymer may vary within wide limits but should be sufficient to provide the polyurethane with the required degree of water-dispersability and crosslinkability.

In another embodiment, the sulfonate salt groups can be introduced in this prepolymer using sulfonated polyesters obtained by the reaction of sulfonated dicarboxylic acids with one or more of the above-mentioned polyhydric alcohols, or by the reaction of sulfonated diols with one or more of the above-mentioned polycarboxylic acids. Suitable examples of sulfonated dicarboxylic acids include 5-(sodiosulfo)-isophthalic acid and sulfoisophthalic acids. Suitable examples of sulfonated diols include sodiosulfohydroquinone and 2-(sodiosulfo)-1,4-butanediol.

In still another embodiment, it is also possible that the hydrophilic compound (iii) comprises any other functional groups which are susceptible to a crosslinking reaction, such as isocyanate, hydroxy, amine, acrylic, allylic, vinyl, alkenyl, alkinyl, halogen, epoxy, aziridine, aldehyde, ketone, anhydride, carbonate, silane, acetoacetoxy, carbodiimide, ureidoalkyl, N-methylolamine, N-methylolamide N-alkoxy-methyl-amine, N-alkoxy-methyl-amide, or the like. Particularly preferred polyols comprising functional groups which are susceptible to a crosslinking reaction are those which comprise the acrylic or methacrylic functionalities, in order to allow radical crosslinking initiated by UV light or electron beam.

Typically, the total amount of the hydrophylic compound (iii) in the polyurethane prepolymer can range from 1 to 40 wt % of the polyurethane polymer, preferably from 4 to 10 wt % .

During the preparation of the isocyanate-terminated polyurethane prepolymer the reactants are generally used in proportions corresponding to a ratio of isocyanate groups to such groups which are enabled to react with the isocyanate functionalities of from about 1.1:1 to about 4:1, preferably from about 1.3:1 to 2:1. The ratio is of paramount importance to fix the level of hard urethane or urea segments in the polymer as well as its molecular weight.

It is recommendable in the frame of this invention to use a sequential process during which the at least one dilsocyanate compound (i) or the at least one organic and hydrophilic compounds (ii) and (iii) are added incrementally in two or several portions, or with a continuous feed. The reason for this is the possibility to have a better control on the exothermicity of the reaction especially in this case were no solvent is present to absorb the heat through the condensation of the refluxing solvent.

The at least one unsaturated compound (iv) have in their molecule at least one unsaturated function such as acrylic, methacrylic or allylic nature and at least one nucleophilic function capable of reacting with isocyanates. The acrylic functionality is preferred for its higher reactivity. Particularly suitable are the acrylic or methacrylic esters with polyols, in wich at least one hydroxy functionality remains free, like hydroxyalkyl(meth)acrylates having 1 to 20 carbon atoms in the alkyl group and having a linear or branched structure. Examples of monounsaturated compounds are hydroxyethylacrylate, hydroxypropylacrylate or hydroxybutylacrylate and the like. Examples of polyunsaturated compounds are trimethylolpropane diacrylates, glycerol diacrylates, pentaerythritol triacrylate, ditrimethylolpropane triacrylate and their polyethoxylated, polypropoxylated or bloc copolymer equivalents. Those products that provide a final composition with a non-irritant character are preferred. For this reason, the monounsaturated products as well as the ditrimethylolpropanetriacrylate are especially appropriate.

It is known to those skilled in the art that acrylation of polyols such as trimethylolpropane and pentaerythritol proceeds to a mixture of monoacrylate, diacrylate, triacrylate and tetraacrylate (when applicable) and that a possible way to characterize the mixture is by measuring its hydroxyl value. In order to modify the respective proportions of the various acrylates formed, it is known to modify reaction parameters such as temperature, nature and amount of reaction catalyst, amount of acrylic acid, etc. For instance, for the purpose of using the mixture of acrylates derived from the acrylation of pentaerythritol as chain-capping agent for the polyurethane polymer of the invention, it is preferable to select the hydroxyl value in the range of 50-250 mg KOH/g, preferably 80-150 mg KOH/g. Reason for such a selection is that when the hydroxyl value is low, then the proportion of pentaerythritol tetraacrylate in the mixture is too high and tends to be detrimental to the flexibility of the cured coating resulting from the aqueous dispersion of the invention.

The acrylated chain terminating agent can be used in such a manner that it is fully converted during the reaction with the available isocyanate groups of the polyurethane prepolymer, i.e. the molar ratio of the said isocyanate groups to the hydroxyl groups is preferably between 1.0 and 2.0. It might be wished for very specific requirements that this ratio is inferior to 1. In particular, it is possible to add non-hydroxylated polyunsaturated compounds that will not react with the isocyanate groups of the prepolymer, and in an excess between 5-50%, preferably between 20-30% based on the weight of the prepolymer to enhance the crosslinking density of the polymer after irradiation.

If desired, the preparation of the polyurethane prepolymer may be carried out in the presence of any of the known catalysts suitable for polyurethane preparation such as amines and organometailic compounds. Examples of these catalysts include triethylenediamine, N-ethyl-morpholine, triethylamine, dibutyltin dilaurate, stannous octanoate, dioctyltin diacetate, lead octanoate, stannous oleate, dibutyltin oxide and the like. Those catalysts that are not volatile organic compounds are preferred.

The neutralising agent (v) is a base compound capable of reacting with carboxylic acids, sulfonic acids or the like to provide a stable anionic salt.

Suitable neutralizing agents for converting the above mentioned acid groups into anionic salt groups during or before the dispersion in water of the polyurethane prepolymers bearing terminal isocyanate groups can be volatile organic bases and/or non-volatile bases. Volatile organic bases are those whereof at least about 90% volatilize during film formation under ambient conditions, whereas non-volatile bases are those whereof at least about 95% do not volatilize during film formation under ambient conditions.

Suitable volatile organic bases can preferably be selected from the group comprising ammonia, trimethylamine, triethylamine, triisopropylamine, tributylamine, N,N-dimethylcyclohexylamine, N,N-dimethylaniline, N-methylmorpholine, N-methylpiperazine, N-methylpyrrolidine and N-methylpiperidine.

Suitable non-volatile inorganic bases include those comprising monovalent metals, preferably alkali metals such as lithium, sodium and potassium. These nonvolatile bases may be used in the form of inorganic or organic salts. preferably salts wherein the anions do not remain in the dispersions such as hydrides, hydroxides, carbonates and bicarbonates.

The polyurethane polymer is reacted with the neutralising agent (v) after step (B) or during step (C). When the neutralisation is made during step (C), the neutralising agent (v) can be an inorganic base compound.

Sodium hydroxyde is the most preferred neutralizing agent.

The total amount of these neutralizing agents should be calculated according to the total amount of acid groups to be neutralized. To ensure that all acid groups are neutralized in the case volatile organic bases are used, it is advisable to add the neutralizing agent in an excess of 5 to 30 wt %, preferably 10 to 20 wt %.

Optionally, a further compound (vi) is added after step (C), which is a polyamine compound capable of making a chain extension of the remaining isocyanate end-groups of the polymer

The chain extender should carry active hydrogen atoms, which react with the terminal isocyanate groups of the polyurethane prepolymer. The chain extender is suitably a water-soluble aliphatic, alicyclic, aromatic or heterocyclic primary or secondary polyamine having up to 80, preferably up to 12 carbon atoms.

The total amount of polyamines should be calculated according to the amount of isocyanate groups present in the polyurethane prepolymer. The ratio of isocyanate groups in the prepolymer to active hydrogens in the chain extender during the chain extension may be in the range of from about 1.0:0.7 to about 1.0:1.1, preferably from about 1.0:0.9 to about 1.0:1.02 on an equivalent basis. This ratio is 1.0:1.0 in order to obtain a fully reacted polyurethane polymer (a polyurethane urea) with no residual free isocyanate groups.

When the chain extension of the polyurethane prepolymer is effected with a polyamine, the total amount of polyamine should be calculated according to the amount of isocyanate groups present in the polyurethane prepolymer.

The degree of non-linearity of the polyurethane polymer is controlled by the functionality of the polyamine used for the chain extension. The desired functionality can be achieved by mixing polyamines with different amine functionalities; for example, a functionality of 2.5 may be achieved by using equimolar mixtures of diamines and triamines. The polyamine has an average functionality of 2 to 4, preferably 2 to 3.

Examples of such chain extenders useful herein comprise hydrazine, ethylene diamine, piperazine, diethylene triamine, triethylene tetramine, tetraethylene pentamine, pentaethylene hexamine, N,N,N-tris(2-aminoethyl)amine, N-(2-piperazinoethyl)ethylene-diamine, N,N′-bis(2-aminoethyl)piperazine, N,N,N′-tris(2-aminoethyl)ethylenediamine, N-[N-(2-aminoethyl)-2-aminoethyl]-N′-(2aminoethyl)piperazine, N-(2-amninoethyl)-N′-(2-piperazinoethyl)ethylenediamine, N,N-bis(2-aminoethyl)-N-(2-piperazinoethyl)amine, N,N-bis(2-piperazinoethyl)amine, guanidine, melamine, N-(2-aminoethyl)-1,3-propanediamine, 3,3′-diaminobenzidine 2,4,6-triaminopyrimidine, dipropylenetriamine, tetrapropylenepentamine, tripropylenetetramine, N,N-bis(6-aminohexyl)amine, N,N′-bis(3-aminopropyl)ethylenediamine, 2,4-bis(4′-aminobenzyl)aniline, 1,4-butanediamine, 1,6-hexanediamine, 1,8-octanediamine, 1,10-decanediamine, 2-methylpentamethylenediamine, 1,12-dodecanediamine, isophorone dismine (or 1-amino3-aminomethyl-3,5,5-trimethyl-cyclohexane), bis(4-aminocyclohexyl)methane [or bis(aminocyclohexane-4-yl)-methane], and bis(4-amino-3-methylcyclohexyl)methane [or bis (amino-2-methylcyclohexane-4-yl) methane], polyethylene amines, polyoxyethylene amines and/or polyoxypropylene amines (e.g. Jeffamines from TEXACO).

In another embodiment, the functional group which is susceptible to water dispersion is a sulfonate group is incorporated into the polyurethane polymer by a chain extension using sulfonated diamines like for example the sodium salt of 2,4-diamino-5-methylbenzenesulfonic acid or the alpha,omega-polypropyleneglycoldiaminesulfopropyl acid.

In a preferred embodiment the chain extender is selected from aliphatic diamines; preferably it is 1,5-diamino-2-methyl-pentane.

The chain extension reaction is generally carried out at a temperature between 5° and 90° C., preferably between 20° to 50° C. and most preferably between 10 and 20° C.

The compositions of the present invention preferably contain an initiator, called a photoinitiator, which starts the crosslinking reaction upon exposure to UV-irradiation. The preferred photoinitiator of the present invention is a low volatile photoinitiator for radical polymerization which is in the liquid form and is easily dispersed or diluted in water to provide a stable and non evolutive formulation. The photoinitiator is preferably used in a concentration from 0.1 to 10% d/d. For example, 1,5% of pure photoinitiator is added to the wet dispersion, giving 4,5% dry on dry for a dry content of 33%.

Photoinitiators which may be used according to the present invention are selected from those conventionally used for this purpose. Suitable photoinitiators include (not limitative) aromatic carbonyl compounds such as benzophenone and its alkyl or halogen derivatives, anthraquinone and its derivatives, thioxanthone and its derivatives, benzoin ethers, aromatic or non-aromatic alpha-diones, benzyl dialkylketals and acetophenone derivatives.

Suitable photoinitiators are, for example, acetophenone, propiophenone, 2-phenyl-acetophenone, 2-chloro-2-phenyl-acetophenone, 2,2-dichloro-2-phenyl-aceophenone, 2-butyloxy-2-phenyl-acetophenone, 2,2-dimethoxy-2-phenyl-acetophenone, 2,2-diethoxy-acetophenone, 2-methylol-2-methoxy-2-phenyl-acetophenone, benzophenone, 4-trichloromethylbenzophenone, indenone, 1,3-indanedione, fluorenone, xanthone, thioxanthone, 2-chlorothioxanthone, anthraquinone, 2-ethylanthraquinone, biacetyl, glyoxal, 1,2-indanedione, p-chlorophenyl-glyoxal, benzil, camphoquinone, benzoin methyl and ethyl ethers, and the like.

The photoinitiating action of the photoinitiator is, in some cases, considerably improved by tertiary amines characterized in that they have at least one hydrogen atom on the carbon atom adjacent to the nitrogen atom. Suitable tertiary amine are: trimethylamine, triethanolamine, N-methyl-diethanolamine, N-N-dimethyl-ethanolamine, N,N-dimethylstearylamine, N,N-dimethylaniline, N,N-di(2-hydroxyethyl)aniline or aminoacrylates such as the addition product of a secondary amine such as dimethylamine, diethylamine, diethanolamine, etc., with a polyol acrylate such as trimethylolpropane diacrylate, etc.

It can be advantageous in certain cases to associate, in the same molecule, the tertiary amine function having at least one hydrogen atom on at least one carbon atom adjacent to the nitrogen atom, with the aromatic ketone function, such as, in for example: 2-isopropyloxy-2-(4-dimethylaminophenyl)propiophenone, 4-dimethylamino-benzophenone, 4,4′-bis(dimethylamino)benzophenone, 2-diethylamino-9-fluorenone, 7-diethylamino-4-methylcoumarin, N-methylacridone, and the like. Similarly, it is possible to associate in the same molecule the tertiary amine function, having at least one hydrogen atom on at least one carbon atom adjacent to the nitrogen atom; with at least one acrylic or methacrylic radical, such as in, for example: the mono-, di- and triacrylates or methacrylates of triethanolamine, of N-methyldiethanolamine, of N,N-dimethylethanolamine or of N,N-di(2-hydroxyethyl)aniline.

For curing the compositions according to the invention by an accelerated electron beam, it is not necessary to use a photoinitiator, since this type of radiation produces by itself a sufficient quantity of energy to produce free radicals and to ensure that curing is extremely rapid.

If desired, the compositions of the present invention may include other auxiliary substances (additives) which may be added to the final composition in order to impart or improve desirable properties or to suppress undesirable properties. These additives include not limitatively the known crosslinkers (e.g. polyaziridines), biocides (e.g. Acticide AS), antioxidants (e.g. Irganox 245), plasticizers (e.g. dioctyl phtalate), pigments (e.g. carbon black), silica sols (e.g. Acemat TS100), leveling agents (i.e. Byk 306), wetting agents (e.g. Byk 346), humectants (e.g. ethylene glycol, 2-pyrrolidinone, 2-methyl-2,4-pentanediol), foam control agents (e.g. Dehydron 1293), thickening agents (e.g. Tylose MH6000), coalescing agents (e.g. Texanol), heat stabilizers, UV-light stabilizers (e.g. Tinuvin 328 or 622).

The composition may also be blended with other polymer dispersions, for example, with polyvinyl acetate, epoxy resins, polyethylene, polystyrene, polybutadiene, polyvinyl chloride, polyacrylate and other homopolymer and copolymer dispersions. Those polymers can eventually bear reactive functionality suitable to alford supplementary crosslinking with the polyurethane dispersion of the invention.

The aqueous dispersions of the invention suitably have a total solids content of from about 5 to 65 wt %, preferably from about 30 to 50 wt %, more preferably from 30 to 35 wt %; a viscosity measured at 25° C. of 50 to 5000 mPa s, preferably 100 to 500 mPa s, a pH value of 7 to 11, preferably of 7 to 8, an average particle size of about 10 to 1000 nm, preferably 30 to 300 nm, more preferably 50 to 100 nm. The film formation temperature may preferably range from 0 to 70° C., more preferably from 0 to 20° C.

The invention also extends to the use of tetramethylxylylene diisocyanate as reactant to prepare a radiation-curable composition which comprises an aqueous dispersion containing at least one polyurethane polymer.

The radiation-curable compositions according to the present invention are preferably curable by the widespread technique of ultraviolet irradiation (e.g. 80 W/cm or 120 W/cm) although electron-beam irradiation (e.g. 50 kGy, 250 kv) is another option, providing extremely rapid curing and allowing use of compositions free of photoinitiator. The cured coatings obtained thereby exhibit excellent adhesion, outstanding water and solvent resistance as well as mechanical strength, durability and flexibility.

Obviously, in the case of the preparation of the polyurethane prepolymer (A′) compounds (i) and (ii) are first made to react, and the polyurethane prepolymer (A′) is then made to react with compound (iv) for making the radiation-curable polyurethane (B′). Of course, compounds (iii), (v) and (vi) are not used. The dry solvent-free unsaturated polyurethane so obtained is used alone or associated with any other saturated or (poly)unsaturated polymer, oligomer or monomer for radiation curing purposes. The photoinitiators and the other auxiliary substances (additives) referred to here above may also be used. The compositions so obtained are used in radcure applications, in powder coatings and hot melt applications.

The invention will now be illustrated by way of examples, where it is shown that the physico-chemical properties and process operations can be modified as desired in order to reach the required performance for the application.

In these examples, the determination of some characteristic values was carried out in accordance with the tests described below.

The dry content was measured by a gravimetric method and expressed in %.

The viscosity was measured at 25° C. with a Brookfleld RVT viscometer using spindle N° 1 at 50 rpm and expressed in mPa.s.

The average particle size of the aqueous polymer dispersions was measured by laser light scattering using a Malvern Particle Analyser type 7027 & 4600SM and expressed in nm.

The grits value is the amount of dry residue from the polymer dispersion filtered on a 50μ sieve and expressed in mg/liter.

Stain resistance: the stain resistance of a coating is assessed by putting a test substance on the coating. The test substances used are teer, black polish, black alcohol pencil, BB750 colorant in water, SR380 colorant in white spirit and SG146 colorant in white spirit. The liquids are applied on the substrate, covered with a microscope glass and left for 4 hours. The stains are washed with a couple of rubs using a tissue saturated with isopropanol. The remaining stains are assessed visually using a 1-5 scale, 5=best. A high value (5) is expected to provide the best protection against any household product spillage.

Flexibility: the flexibility of the coated PVC can be assessed at room temperature or at −10° C. At room temperature, the coated material is folded at 90° then at 180° and the defects (cracks, loss of adhesion) are recorded on a 1-5 scale, 5=best. At −10°, the coated reference material is becoming stiff, and it is then 90° folded on the edge of a table in the two transversal directions; the break of the substrate is recorded on a 1-5 scale, 5=no break. A high value (5) is expected to generate no defects upon manipulation of the flexible substrate.

Double rubs: the double rubs are made with a peace of cotton rag saturated with water, water ethanol 1:1 or isopropanol depending on the conditions; one double rub is equal to a forward and backward stroke. The reported number is the number of double rubs required to break through the coating. A high value (>100) is expected for optimum coating resistance.

Resolubility: A wet film of 100μ is made on glass. Water droplets are put on the surface during the drying of the film, and an attempt is made to resolubilise the drying coating with the aid of the finger. The resolubility is expressed by the open time (minutes) left before skins or grits are irreversibly formed under the finger. A high value (>60 minutes) is expected to have no irreversible drying defect during the application of the inks by flexography, heliography or in kjet.

Adhesion: The adhesion was measured using an adhesive tape firmly pressed on the coating and removed rapidly; the damage to the coating due to adhesion loss is expressed in a 1-5 scale, 5=best. A high adhesion (5) is necessary to ensure a strong permanent bond between the coating and the substrate.

Gloss: The gloss of the coated film was measured using a Gardner gloss meter with an incident light of 60° angle. High gloss value (>75) are perceived as an advantage in many markets.

### EXAMPLE 1 (triethylamine)

A double-wall glass reactor equipped with a mechanical stirrer, a thermocouple, a vapor condenser and a dropping funnel is charged with. 190.0 g of a polyester having an average molecular weight ˜670 Dalton (obtained by the polycondensation of adipic acid and neopentylglycol), 53.2 g of dimethylol propionic acid, 24.5 g of cyclohexane dimethanol, 332.2 g of tetramethylxylylenediisocyanate, 2.3 g of Irganox 245, 4.6 g of Tinuvin 328, 4.6 g of Tinuvin 622 and 0.6 g of dibutyltinlaurate solution in acetone (at 10%) as reaction catalyst. The reaction mixture is heated up to 90° C. with stirring, and the condensation process is maintained until the isocyanate content reaches 1.67 meq/g. The polyurethane prepolymer is cooled down to 70° C. 0.18 g of 4-methoxyphenol dissolved in 314.9 g of pentaerytrytoltriacrylate (PETIA) is added to the vessel. The reaction mixture is kept at 70° C., and the end-capping process is maintained until the isocyanate content reaches 0.42 meq/g. Then, 40.6 g of triethylamine is added as neutralizing agent in the warm prepolymer until homogenous. 1722 g of water at room temperature is loaded in the reactor under vigorous mixing and beyond the phase inversion point. A stable polymer dispersion is obtained after about 5 minutes of vigorous mixing, but the agitation is maintained over a period of 1 hour. 2.6 g of Acticide AS is added as a biocide. The product is filtered over a 100μ sieve. It has a dry content of 32.9%, a viscosity of 33 mPa.s, a pH of 7.8. a particle size of 48 nm and a grits content of <100 mg/l. It contains no solvent.

### EXAMPLE 2 (NaOH)

A double-wall glass reactor equipped with a mechanical stirrer, a thermocouple, a vapour condenser and a dropping funnel is charged with. 190.0 g of a polyester having an average molecular weight ˜670 Dalton (obtained by the polycondensation of adipic acid and neopentylglycol), 53.2 g of dimethylol propionic acid, 24.5 g of cyclohexane dimethanol, 332.2 g of tetramethylxylylenediisocyanate, 2.2 g of Irganox 245, 4.5 g of Tinuvin 238, 4.5 g of Tinuvin 622 and 0.6 g of dibutyltinlaurate solution in acetone (at 10%) as reaction catalyst. The reaction mixture is heated up to 90° C. with stirring, and the condensation process is maintained until the isocyanate content reaches 1.67 meq/g. The polyurethane prepolymer is cooled down to 70° C. 0.18 g of 4-methoxyphenol dissolved in 302.4 g of pentaerythrytoltriacrylate (PETIA) is added to the vessel. The reaction mixture is kept at 70° C., and the end-capping process is maintained until the isocyanate content reaches 0.45 meq/g. Then, 16.1 g of caustic soda in 560 g of water at room temperature is added as neutralising agent in the reactor under vigorous mixing, followed with a second addition of 1140 g of water beyond the phase inversion point. A stable polymer dispersion is obtained after about 5 minutes of mixing, but the agitation is maintained over a period of 1 hour. 2.6 g of Acticide AS is added as a biocide. The product is filtered over a 100μ sieve. It has a dry content of 33.4%, a viscosity of 20 mPa.s, a pH of 7.2, a particle size of 75 nm and a grits content of <100 mg/l. It contains neither solvent nor amines.

The dispersions are formulated with 1.5% of Irgacure 500 (a photoinitiator marketed by Ciba). They are applied on white PVC, and cured under UV-light @ 5 m/min, 80W/cm.

| | |
|---|---|
| Ex 1 | Ex 2 |

Ageing of dispersion (1 month @ 40° C.) prior to coating

| | | |
|---|---|---|
| Particle size (nm) | 133 | 126 |
| Sedimentation (visual) | very small deposit | no deposit |
| Cracks (visual, 1-5 best) | 5 | 5 |
| Yellowing (visual, 1-5 best) | 5 | 5 |
| Flexibility (visual, 1-5 best) | 4 | 2 |
| Stain resistance (max 5) | 4.9 | 4.7 |
| Double rubs (ethanol 50%) | >100 | >100 |
| Double rubs (isopropanol) | >100 | >100 |

Ageing of coating (1 month @ 40° C.)

| | | |
|---|---|---|
| Yellowing (visual, 1-5 best) | 5 | 5 |
| Cracks (visual, 1-5 best) | 5 | 5 |
| Flexibility (visual, 1-5 best) | 4 | 2 |
| Stain resistance (max 5) | 5 | 4.9 |
| Double rubs (ethanol 50%) | >100 | >100 |
| Double rubs (isopropanol) | >100 | >100 |

Ageing of coating (3 weeks @ 70° C., 95% humidity)

| | | |
|---|---|---|
| Yellowing (visual, 1-5 best) | 3 | 3 |
| Cracks (visual, 1-5 best) | 3 | 2 |
| Flexibility (visual, 1-5 best) | 5 | 5 |
| Stain resistance (max 5) | 3.9 | 3.5 |
| Double rubs (ethanol 50%) | >100 | >100 |
| Double rubs (isopropanol) | >100 | >100 |

### CONCLUSIONS OF EXAMPLES 1-2

The radiation curable polyurethane dispersions based on TMM can be made by substituting the neutralisation with a volatile organic amine by that of a non-volatile inorganic salt (caustic soda) without detrimental depression of the coating performance after cure. There is however a trend for example 2 to be somewhat better for stability, and somewhat worse for flexibility and cracks upon ageing.

### EXAMPLE 3 Irritant-free, Triethylamine

A double-wall glass reactor equipped with a mechanical stirrer, a thermocouple, a vapour condenser and a dropping funnel is charged with. 205.9 g of a polyester having an average molecular weight ˜670 Dalton (obtained by the polycondensation of adipic acid and neopentylglycol), 57.6 g of dimethylol propionic acid, 26.6 g of cyclohexane dimethanol, 359.9 g of tetramethylxylylenediisocyanate, 0.65 g of dibutyltinlaurate solution in acetone at 10% as reaction catalyst, 2.41 g of Irganox 245 (a photoinitiator sold by Ciba), 4.82 g of Tinuvin 328 (a UV-absorber sold by Ciba) and 4.42 g of Tinunvin 622 (a Hindered Amine Light Stabilizer sold by Ciba). The reaction mixture is heated up to 90° C. with stirring. After the exotherm, the reaction is kept at 100° C. until the isocyanate content reaches 1.67 meq/g. The polyurethane prepolymer is cooled down to 80° C. 0.38 g of 4-methoxyphenol dissolved in 313 g of di-trimethylolpropane-tri-acrylate is added slowly to the vessel. The reaction mixture is kept at 80° C. until the isocyanate content reaches 0.45 meq/g. Then, 44 g of triethylamine in 613 g of water at room temperature is added to the warm end-capped prepolymer until homogenous. 1200 g of water at room temperature is further loaded in the reactor under vigorous mixing, and a stable polymer dispersion is obtained after phase inversion. The dispersion is cooled down below 30° C. 2.79 g of Acticide AS are added as a biocide. The product is filtered over a 100μ sieve. It has a dry content of 32.5%, a viscosity of 22 mPa.s, a pH of 7.0, a particle size of 67 nm and a grits content of <100 mg/l. It contains no solvent and is not irritant.

### EXAMPLE 4 Irritant-free (NaOH)

A double-wall glass reactor equipped with a mechanical stirrer, a thermocouple, a vapor condenser and a dropping funnel is charged with. 205.9 g of a polyester having an average molecular weight ˜670 Dalton (obtained by the polycondensation of adipic acid and neopentylglycol), 57.6 g of dimethylol propionic acid, 26.6 g of cyclohexane dimethanol, 359.9 g of tetramethylxylylenediisocyanate, 0.65 g of dibutyltinlaurate solution in acetone (at 10%) as reaction catalyst, 2.41 g of Irganox 245, 4.82 g of Tinuvin 328 and 4.42 g of Tinunvin 622. The reaction mixture is heated up to 90° C. with stirring. After the exotherm, the reaction is kept at 100° C. until the isocyanate content reaches 1.67 meq/g. The polyurethane prepolymer is cooled down to 80° C. 0.38 g of 4-methoxyphenol dissolved in 313 g of di-trimethylolpropane-tri-acrylate is added slowly to the vessel. The reaction mixture is kept at 80° C. until the isocyanate content reaches 0.45 meq/g. Then, 17.42 g of caustic soda in 616 g of water at room temperature is added to the warm end-capped prepolymer until homogenous. 1200 g of water at room temperature is further loaded in the reactor under vigorous mixing, and a stable polymer dispersion is obtained after phase inversion. The dispersion is cooled down below 30° C. 2.79 g of Acticide AS are added as a biocide. The product is filtered over a 100μ sieve. It has a dry content of 32.8%, a viscosity of 26 mPa.s, a pH of 7.7, a particle size of 57 nm and a grits content of <100 mg/l. It contains no solvent and is not irritant.

The products were formulated with 1.5% of Irgacure 500 as a photoinitiator and 1-3% of UCECOAT XE430/water (1:1) as a thickener. They were applied on thick white PVC at a thickness of ˜12μ. The coating was irradiated at 80 W/cm and at a speed of 5 m/min.

| | Ex 3 | Ex 4 |
|---|---|---|
| Flexibility (1-5 best) | 5 | 5 |
| Flexibility @-10° (1-5, best) | 5 | 5 |
| Stain resistance (max 5) | 4.4 | 4.5 |
| Double rubs (ethanol 50%) | >100 | >100 |
| Double rubs (white spirit) | >100 | >100 |

### CONCLUSIONS OF EXAMPLES 3-4

The radiation curable polyurethane dispersions based on TMXI can be made so that they combine the absence of volatile organic compounds and amines with no irritant character to the skin and eyes and with superior coating performance after cure.

### EXAMPLE 5 (Soft Version, Triethylamine)

A double-wall glass reactor equipped with a mechanical stirrer, a thermocouple, a vapor condenser and a dropping funnel is charged with. 491.9 g of a polyester having an average molecular weight ˜2000 Dalton (obtained by the polycondensation of adipic acid and neopentylglycol), 28.7 g of dimethylol propionic acid, 179.4 g of tetramethylxylylenediisocyanate, 0.7 g of dibutyltinlaurate solution in acetone (at 10%) as reaction catalyst, 2.17 g of Irganox 245, 4.352 g of Tinuvin 328 and 4.35 g of Tinunvin 622. The reaction mixture is heated up to 90° C. with stirring. After the exotherm, the reaction is kept at 100° C. until the Isocyanate content reaches 0.78 meq/g. The polyurethane prepolymer is cooled down to 80° C. 0.35 g of 4-methoxyphenol dissolved in 169.1 g of pentaerythrytoltriacrylate (PETIA) is added slowly to the vessel. The reaction mixture is kept at 80° C. until the Isocyanate content reaches 0.24 meq/g. Then, 21.88 g of triethylamine in 545 g of water at room temperature is added to the warm end-capped prepolymer until homogenous. 1090 g of water at room temperature is further loaded in the reactor under vigorous mixing, and a stable polymer dispersion is obtained after phase inversion. The dispersion is cooled down below 30° C. 2.51 g of Acticide AS are added as a biocide. The product is filtered over a 100μ sieve. It has a dry content of 33.3%, a viscosity of 15 mPa.s, a pH of 7.1, a particle size of 234 nm and a grits content of <100 mg/l. It contains no solvent.

### EXAMPLE 6 (Hard Version, Triethylamine)

A double-wall glass reactor equipped with a mechanical stirrer, a thermocouple, a vapor condenser and a dropping funnel is charged with. 158.4 g of a polyester having an average molecular weight ˜670 Dalton (obtained by the polycondensation of adipic acid and neopentylglycol), 44.3 g of dimethylol propionic acid, 20.4 g of cyclohexane dimethanol, 276.8 g of tetramethylxylylenediisocyanate, 0.5 g of dibutyltinlaurate solution in acetone (at 10%) as reaction catalyst, 1.89 g of Irganox 245, 3.77 g of Tinuvin 328 and 3.77 g of Tinunvin 622. The reaction mixture is heated up to 90° C. with stirring. After the exotherm, the reaction is kept at 100° C. until the isocyanate content reaches 1.67 meq/g. The polyurethane prepolymer is cooled down to 80° C. 0.15 g of 4-methoxyphenol dissolved in 254.9 g of pentaerythrytoltriacrylate (PETIA) is added slowly to the vessel. The reaction mixture is kept at 80° C. until the isocyanate content reaches 0.44 meq/g. 251.6 g of EBECRYL 1290 (a urethane acrylate oligomer from UCB Chemicals) is added to the mixture to increase the acrylic unsaturation level. Then, 33.7 g of triethylamine in 525 g of water at room temperature is added to the warm end-capped prepolymer until homogenous. 1000 g of water at room temperature is further loaded in the reactor under vigorous mixing, and a stable polymer dispersion is obtained after phase inversion. The dispersion is cooled down below 30° C. 2.54 g of Acticide AS are added as a biocide. The product is filtered over a 100μ sieve. It has a dry content of 37.4%, a viscosity of 28 mPa.s, a pH of 7.3, a particle size of 94 nm and a grits content of <100 mg/l. It contains no solvent.

The products were formulated with 1.5% of Irgacure 500 as a photoinitiator and 1-3% of XE430/water 1:1 as a thickener. They were applied on thick white PVC at a thickness of ˜12μ. The coating was irradiated at a speed of 5 m/min and at 80 W/cm.

| | Ex 5 | Ex 6 |
|---|---|---|
| Flexibility (1-5, best) | 5 | 5 |
| Flexibility @-10° (1-5, best) | 5 | 3 |
| Stain resistance (max 5) | 2.8 | 5 |
| Double rubs (ethanol 50%) | >100 | >100 |
| Double rubs (isopropanol) | >100 | >100 |

### CONCLUSION OF EXAMPLES 5-6

The radiation curable polyurethane dispersions based on TMXI can cover a wide range of mechanical properties and performances after cure going from soft and flexible coatings to hard and brittle coatings.

### EXAMPLE 7 (Hydrophilic Version, Triethylamine)

A double-wall glass reactor equipped with a mechanical stirrer, a thermocouple, a vapor condenser and a dropping funnel is charged with. 340.6 g of a polyether being a tri-bloc copolymer made of 10% polyethylene oxide and 90% polyoxypropylene units and having an average molecular weight ˜2750 Dalton, 32.2 g of dimethylol propionic acid, 16.7 g of cyclohexane dimethanol, 210.5 g of tetramethylxylylenediisocyanate, 0.6 g of dibutyltinlaurate solution in acetone (at 10%) as reaction catalyst, 2.33 g of Irganox 245, 4.66 g of Tinuvin 328 and 4.66 g of Tinunvin 622. The reaction mixture is heated up to 90° C. with stirring. After the exotherm, the reaction is kept at 100° C. until the isocyanate content reaches 1.25 meq/g. The polyurethane prepolymer is cooled down to 80° C. 0.37 g of 4-methoxyphenol dissolved in 331 g of pentaerythrytoltriacrylate (PETIA) is added slowly to the vessel. The reaction mixture is kept at 80° C. until the isocyanate content reaches 0 meq/g. Then, 24.6 g of triethylamine in 552 g of water at room temperature is added to the warm end-capped prepolymer until homogenous. 1200 g of water at room temperature is further loaded in the reactor under vigorous mixing, and a stable polymer dispersion is obtained after phase inversion. The dispersion is cooled down below 30° C. 2.69 g of Acticide AS are added as a biocide. The product is filtered over a 100μ sieve. It has a dry content of 33.60%, a viscosity of 37 mPa.s, a pH of 7.2, a particle size of 88 nm and a grits content of <100 mg/l. It contains no solvent.

### EXAMPLE 8 (Hydrophilic Version, NaOH)

A double-wall glass reactor equipped with a mechanical stirrer, a thermocouple, a vapor condenser and a dropping funnel is charged with. 340.6 g of a polyether being a tri-bloc copolymer made of 10% polyethylene oxide and 90% polyoxypropylene units and having an average molecular weight ˜2750 Dalton, 32.2 g of dimethylol propionic acid, 16.7 g of cyclohexane dimethanol, 210.5 g of tetramethylxylylenediisocyanate, 0.6 g of dibutyltinlaurate solution in acetone (at 10%) as reaction catalyst, 2.33 g of Irganox 245, 4.66 g of Tinuvin 328 and 4.66 g of Tinunvin 622. The reaction mixture is heated up to 90° C. with stirring. After the exotherm, the reaction is kept at 100° C. until the isocyanate content reaches 1.25 meq/g. The polyurethane prepolymer is cooled down to 80° C. 0.37 g of 4-methoxyphenol dissolved in 331 g of pentaerythrytoltriacrylate (PETIA) is added slowly to the vessel. The reaction mixture is kept at 80° C. until the isocyanate content reaches 0 meq/g. Then, 9.73 g of caustic soda in 552 g of water at room temperature is added to the warm end-capped prepolymer until homogenous. 1200 g of water at room temperature is further loaded in the reactor under vigorous mixing, and a stable polymer dispersion is obtained after phase Inversion. The dispersion is cooled down below 30° C. 2.69 g of Acticide AS are added as a biocide. The product is filtered over a 100μ sieve. It has a dry content of 33.1%, a viscosity of 33 mPa.s, a pH of 7.2, a particle size of 92 nm and a grits content of <100 mg/l. It contains neither solvent nor amine.

The products were formulated with 1.5% of Irgacure 500 as a photoinitiator and 1-3% of XE430/water 1:1 as a thickener. They were applied on white-printed polypropylene films at a thickness of ˜4μ. The coating was irradiated at a speed of 5 m/min and at 80 W/cm.

| | Ex 7 | Ex 8 |
|---|---|---|
| Resolubility (minutes) | >60 | >60 |
| Adhesion (1-5, best) | 5 | 5 |
| Flexibility (1-5 best) | 5 | 5 |
| Gloss | 73 | 70 |
| Double rubs (water) | >100 | >100 |
| Double rubs (isopropanol) | <100 | >100 |

### CONCLUSION OF EXAMPLES 7-8

The radiation curable polyurethane dispersions made from TMXI can be made hydrophilic enough to provide an excellent water resolubility of the coating before cure associated with an excellent resistance & flexibility profile of the coating after cure. They exhibit a high gloss.

### EXAMPLE 9 (Sequential Process, Triethylamine)

A double-wall glass reactor equipped with a mechanical stirrer, a thermocouple, a vapor condenser and a dropping funnel is charged with. 332.2 g of tetramethylxylylenediisocyanate and heated to 60° C. It is loaded with 95 g of a polyester having an average molecular weight ˜670 Dalton (obtained by the polycondensation of adipic acid and neopentylglycol), 26.6 g of dimethylol propionic acid, 12.2 g of cyclohexane dimethanol, 0.6 g of dibutyltinlaurate solution in acetone (at 10%) as reaction catalyst, 2.2 g of Irganox 245, 4.4 g of Tinuvin 328 and 4.4 g of Tinunvin 622. The reaction mixture is heated up to 90° C. with stirring. After the exotherm, the reaction mixture is cooled down to 60° C. It is loaded again with 95 g of a polyester having an average molecular weight ˜670 Dalton (obtained by the polycondensation of adipic acid and neopentylglycol), 26.6 g of dimethylol propionic acid and 12.2 g of cyclohexane dimethanol. The reaction mixture is heated to 100° C. until the isocyanate content reaches 1.67meq/g. The polyurethane prepolymer is cooled down to 80° C. 0.36 g of 4-methoxyphenol dissolved in 293.4 g of pentaerythrytoltriacrylate (PETIA) is added slowly to the vessel. The reaction mixture is kept at 80° C. until the isocyanate content reaches 0.48 meq/g. Then, 40.6 g of triethylamine in 560 g of water at room temperature is added to the warm end-capped prepolymer until homogenous. 1120 g of water at room temperature is further loaded in the reactor under vigorous mixing, and a stable polymer dispersion is obtained after phase inversion. The dispersion is cooled down below 30° C. 2.58 g of Acticide AS are added as a biocide. The product is filtered over a 100μ sieve. It has a dry content of 33.2%, a viscosity of 20 mPa.s, a pH of 7.0, a particle size of 101 nm and a grits content of <100) mg/l. It contains no solvent.

| | Ex 1 | Ex 9 |
|---|---|---|
| Flexibility (1-5 best) | 3 | 3 |
| Flexibility @-10° (1-5, best) | 5 | 5 |
| Stain resistance (max 5) | 5 | 5 |
| Double rubs (ethanol 50%) | >100 | >100 |
| Double rubs (isopropanol) | >100 | >100 |

### CONCLUSION OF EXAMPLE 9

A radiation-curable polyurethane dispersion based on TMXI can be made with a sequential monomer addition process which is beneficial for the control of the reaction exothermicity without being detrimental to the performance of the crosslinked coating.

### EXAMPLE 10 (Comparative Example: Unsaturation-free Version, Triethylamine)

A double-wall glass reactor equipped with a mechanical stirrer, a thermocouple, a vapor condenser and a dropping funnel is charged with. 95.3 g of a polyester having an average molecular weight ˜670 Dalton (obtained by the polycondensation of adipic acid and (neopentylglycol+butanediol 1:1 (moles)}), 95.3 g of a polyester having an average molecular weight ˜700 Dalton (obtained by the polycondensation of adipic acid and butanediol), 16.52 g of dimethylol propionic acid, 1.65 g of trimethylolpropane, 122.1 g of tetramethylxylylenediisocyanate, 0.33 g of dibutyltinlaurate solution in N-methylpyrrolidone (at 10%) as reaction catalyst, 0.83 g of Irganox 245, 1.65 g of Tinuvin 328 and 1.65 g of Tinunvin 622. The reaction mixture is heated up to 90° C. with stirring until the isocyanate content reaches 1.02 meq/g. The polyurethane prepolymer is cooled down to 50° C., and 10.58 g of triethylamine plus 3.61 g of 2-dimethylamino˜2-methyl-1-propanol (80% in water) are added as neutralising agent until homogenous. 560 g of water at room temperature is further loaded in the reactor under vigorous mixing, and a stable polymer dispersion is obtained after phase inversion. The dispersion is cooled down below 20° C., and a chain extension is made by adding dropwise 15.1 g of 1,3-bis(aminomethyl)cyclohexane and 4 g of propylenediamine and waiting about 1 hour for the full completion of the reaction. 2.79 g of Acticide AS are added as a biocide. The product is filtered over a 100μ sieve. It has a dry content of 35.0%, a viscosity of 500 mPa.s, a pH of 8.3, a particle size of about 90 nm and a grits content of <100 mg/l. It contains no solvent.

The products were formulated with 1.5% of Irgacure 500 as a photoinitiator and 1-3% of XE430/water (1:1) as a thickener. They were applied on thick white PVC at a thickness of ˜12μ. The coating was irradiated at a speed of 5 m/min and at 80 W/cm.

| | Ex 1 | Ex 10 |
|---|---|---|
| Flexibility (1-5 best) | 3 | 5 |
| Flexibility @-10° (1-5, best) | 5 | 5 |
| Stain resistance (max 5) | 5 | 1.4 |
| Double rubs (ethanol 50%) | >100 | <10 |
| Double rubs (isopropanol) | >100 | <10 |

### CONCLUSION OF COMPARATIVE EXAMPLE 10

A fully reacted polyurethane dispersion based on TMXI which is not radiation-curable results in a coating with dramatically reduced resistance.

### EXAMPLE 11

### Comparative Example: H12MDI-version, Triethylamine

A double-wall glass reactor equipped with a mechanical stirrer, a thermocouple, a vapor condenser and a dropping funnel is charged with. 213 g of a polyester having an average molecular weight ˜670 Dalton (obtained by the polycondensation of adipic acid and neopentylglycol), 59.6 g of dimethylol propionic acid, 27.5 g of cyclohexane dimethanol, 2.6 g of Irganox 245, 5.2 g of Tinuvin 328, 5.2 g of Tinunvin 622, 400.0 g of 4,4′-didicyclohexylmethane dilsocyanate, 300.0 g of acetone, 0.1 g of dibutyltinlaurate solution in acetone (at 10%) as reaction catalyst. The reaction mixture is heated up to ˜60° C. with stirring. After the exotherm, the reaction is kept under refluxing acetone until the isocyanate content reaches 1.14 meq/g. Then, 0.27 g of 4-methoxyphenol dissolved in 335.0 g of IRR291 (a trifunctional polyol acrylate from UVB Chemicals, having a hydroxyl value of 70 mg KOH/g and an acid value of <5 mg KOH/g) is added slowly to the vessel. The reaction mixture is kept at reflux until the isocyanate content reaches 0.34 meq/g. The reaction mixture is cooled down to 45° C. 44.96 g of triethylamine is added to the warm prepolymer and mixed until homogenous. Then, 1877.0 g of water at room temperature is added slowly until the inversion point is reached, then the rest of water is added under strong agitation until a stable polymer dispersion is obtained. 2.96 g of Acticide AS are added as a biocide. The acetone is stripped off under vacuum until the remaining level falls below 0.15%. The polymer dispersion is cooled down below 30° C., and filtered over a 100μ sieve. It has a dry content of 35.0%, a viscosity of 100 mPa.s, a pH of 7.5, a particle size of 100 nm and a grits content of <100 mg/l. It contains traces of acetone.

The products were formulated with 1.5% of Irgacure 500 as a photoinitiator and 1-3% of XE430/water (1:1) as a thickener. They were applied at a thickness of ˜12μ on thick white PVC or on thick polypropylene (adhesion test). The coating was irradiated at a speed of 5 m/min and at 80 W/cm.

| | Ex 1 | Ex 11 |
|---|---|---|
| Flexibility (1-5 best) | 3 | 5 |
| Flexibility @-10° (1-5, best) | 5 | 1 |
| Stain resistance (max 5) | 5 | 3.6 |
| Adhesion* (max 5) | 5 | 0 |
| Double rubs (ethanol 50%) | >100 | >100 |
| Double rubs (isopropanol) | >100 | 90-100 |

*on thick polypropylene

### CONCLUSION OF COMPARATIVE EXAMPLE 11

An unsaturated polyurethane dispersion based on another diisocyanate than TMXI (here 4,4′-dicyclohexylmethane diisocyanate) still contains traces of solvents and provides a crosslinked coating with a lower flexibility, resistance & adhesion.

### EXAMPLE 12

### Comparative Example with Solvent in the Process

A double-wall glass reactor equipped with a mechanical stirrer, a thermocouple, a vapour condenser and a dropping funnel is charged with. 133.0 g of a polyester having an average molecular weight ˜670 Dalton (obtained by the polycondensation of adipic acid and neopentylglycol), 37.2 g of dimethylol propionic acid, 17.2 g of cyclohexane dimethanol, 232.6 g of tetramethylxylylenediisocyanate, 0.6 g of dibutyltinlaurate solution in acetone (at 10%) as reaction catalyst and 180.0 g of acetone as a solvent. The reaction mixture is heated up to solvent reflux at 56° C. with stirring, and the condensation process is maintained until the isocyanate content reaches 1.18 meq/g. 0.165 g of 4-methoxyphenol dissolved in 223.6 g of pentaerythrytoltriacrylate (PETIA) is added to the vessel, and the end-capping reaction is kept at solvent reflux. The reaction mixture gelifies well before the isocyanate content reaches the target of 0.32 meq/g.

### CONCLUSION OF COMPARATIVE EXAMPLE 12

The synthesis leads to a gelification of the prepolymer happening during the stage of end-capping with the PETIA; it illustrates the fact that the reaction can not take place in the presence of an organic solvent such as acetone, while it is easily done in the absence of solvents.

### EXAMPLE 13

### Example where the Unsaturated Polyurethane is Collected Dry

A double-wall glass reactor equipped with a mechanical stirrer, a thermocouple, a vapor condenser and a dropping funnel is charged with 316.75 g of a polyester having an average molecular weight ˜670 Dalton and obtained by the polycondensation of adipic acid and neopentylglycol, 88.69 g of dimethylol propionic acid, 40.85 g of cyclohexane dimethanol, 553.71 g of tetramethylxylylenediisocyanate and 1.00 g of dibutyltinlaurate solution in acetone (at 10%) as reaction catalyst. The reaction mixture is heated up to 90° C. with stirring and an exotherm is recorded to about 105° C. The condensation process is maintained at 90° C. until the isocyanate content reaches 1.67 meq/g. The polyurethane prepolymer is cooled down to 70° C. 0.48 g of 4-methoxyphenol dissolved in 198.36 g of 2-hydroxyethylacrylate (HEA) is added to the vessel. The reaction mixture is kept at 70° C., and the end-capping process is maintained until completion when the isocyanate content nearly reaches 0 meq/g. Then, the warm & viscous oligomer is collected from the reactor and is allowed to cool down to room temperature. The cold oligomer becomes a solid and contains no solvent.

### EXAMPLE 14

### Comparative Example where the Unsaturated polyurethane is Collected Dry

A double-wall glass reactor equipped with a mechanical stirrer, a thermocouple, a vapor condenser and a dropping funnel is charged with 253.40 g of a polyester having an average molecular weight ˜670 Dalton and obtained by the polycondensation of adipic acid and neopentylglycol, 70.95 g of dimethylol propionic acid, 32.68 g of cyclohexane dimethanol, 442.96 g of tetramethylxylylenediisocyanate and 0.80 g of dibutyltinlaurate solution in acetone (at 10%) as reaction catalyst. The reaction mixture is heated up to 90° C. with stirring and an exotherm is recorded to about 105° C. The condensation process is maintained at 90° C. until the isocyanate content reaches 1.67 meq/g. The polyurethane prepolymer is cooled down to 70° C. 0.59 g of 4-methoxyphenol dissolved in 675.92 g of pentaerythrytoltriacrylate (PETIA) is added to the vessel. The reaction mixture is kept at 70° C., and the end-capping process is maintained until completion when the isocyanate content nearly reaches 0 meq/g. Then, the warm & viscous oligomer is collected from the reactor and is allowed to cool down to room temperature. The cold oligomer becomes a solid and contains no solvent.

| | Example 13 | Example 14 |
|---|---|---|
| Functionality, meq acrylates/g | 1.43 | 4.60 |
| Tg, ° C. | 13 | −4 |
| Mw, Daltons | ˜5.000 | ˜5.000 |
| Tack at RT | Very low | Low |
| Viscosity at RT | Solid, no flow | Solid, limited flow |
| Viscosity, mPa · s at 120° C. | ˜2.000 | ˜1.700 |
| Viscosity, mPa · s at 140° C. | ˜700 | ˜1.000 |
| Viscosity, mPa · s at 1:1 in | ˜10.000 | ˜5.000 |
| TPGDA | | |
| Stability, min at 140° C. | 27 | >30 |
| Solubility in TPGDA | Soluble (slow) | Soluble (slow) |

The 2 oligomers were used in a blend (Example 13-14 (13.3%)—TPGDA (53.3%)—EB1290 (33.3%)) with 1.5% Irgacure 500 and 1% Byk346. They were applied at ˜12 g/m2 on white thick PVC film. They were cured 4×5 m/min at 80 W/cm.

| | Example 13 | Example 14 |
|---|---|---|
| Clarity | 5 | 5 |
| Gloss at 60° | ˜90 | ˜90 |
| Adhesion | 5 | 5 |
| Double rubs, IPA | >100 | >100 |
| Double rubs, acetone | >100 | >100 |
| Stain resistance (Marker/Tar) | 5/5 | 5/5 |
| Scratch resistance | 5 | 5 |
| Flexibility at RT | 2 | 2 |

The dry unsaturated polyurethanes can serve as a component of 100% liquid radiation curable compositions to which it can impart desirable properties to the cured film (balance between gloss, adhesion, resistance, flexibility) due to its unique chemical nature (polyurethane, molecular weight, carboxylic and acrylate functionality).

By extension, it can be used in other radiation curable compositions like UV-powders or UV-warm melts & UV-hot melts.

1. A radiation-curable composition which comprises an aqueous dispersion containing at least one ethylenically unsaturated polyurethane polymer which is formed from a polyurethane prepolymer (A) prepared from:
(i) at least one diisocyanate compound containing tetramethylxylylene diisocyanate as a major component,
(ii) at least one organic compound containing at least two reactive groups which can react with isocyanate groups, and
(iii) at least one hydrophilic compound, which is capable to render the polyurethane polymer dispersible in aqueous medium, and the polyurethane prepolymer (A) is reacted with:
(iv) at least one unsaturated compound containing at least one reactive group which can react with isocyanate groups, and at least one ethylenic unsaturation, to form an ethylenically unsaturated, radiation-curable polyurethane polymer (B).

2. Radiation-curable composition according to claim 1, wherein compound (ii) is a polyol compound.

3. Radiation-curable composition according to claim 2, wherein compound
(ii) is a polyester polyol having a molecular weight not higher than 5000.

4. Radiation-curable composition according to claim 1, wherein compound (iii) is a compound containing anionic salt functional groups or acid groups which may be subsequently converted into such anionic salt groups.

5. Radiation-curable composition according to claim 4, wherein the anionic salt groups of compound (iii) are sulfonate or carboxylate salt groups.

6. Radiation-curable composition according to claim 5, wherein the anionic salt groups of compound (iii) are carboxylate salt groups derived from a hydroxycarboxylic acid represented by the general formula (HO)ₓR(COOH)_{y}; wherein R represents a straight or branched chain hydrocarbon radical having 1 to 12 carbon atoms, and x and y are integers from 1 to 3.

7. Radiation-curable composition according to claim 1 wherein unsaturated compound (iv) is a compound selected in such a way that it does not induce irritancy to the final dispersion, and is preferably ditrimethylolpropane triacrylate.

8. A method of coating a substrate which comprises coating a radiation-curable composition according to claim 1 to prepare a coating on a substrate.

9. Process for the preparation of a radiation-curable composition which comprises a polyurethane-containing dispersion, which process comprises:
(A) forming a polyurethane prepolymer by reacting:
(i) at least one diisocyanate compound containing tetramethylxylylene diisocyanate,
(ii) at least one organic compound containing at least two reactive groups which can react with isocyanates groups,
(iii) at least one hydrophilic compound ensuring water dispersibility of the polymer
(B) forming a polyurethane polymer containing radiation-curable ethylenic unsaturations by reacting the polyurethane prepolymer with:
(iv) at least one unsaturated compound containing at least one reactive group which can react with isocyanate groups and at least one ethylenic unsaturation able to provide radiation-curability of the polymer,
(C) dispersing a composition comprising the polyurethane polymer in an aqueous medium and optionally reacting the polyurethane polymer with at least one neutralising agent before or during the dispersion in water.

10. Process according to claim 9, wherein reaction (A) of forming a polyurethane prepolymer is specifically effected in absence of solvent.

11. Process according to claim 9, wherein the neutralising agent (v) is a base compound.

12. Process according to claim 9, wherein the polyurethane polymer is reacted with a neutralising agent (v) after step (B).

13. Process according to claim 9, wherein the polyurethane polymer is reacted with a neutralising agent (v) during step (C).

14. Process according to claim 9, wherein the neutralising agent (v) is a volatile amine compound.

15. Process according to claim 13, wherein the neutralising agent (v) is a non-volatile inorganic compound, preferably caustic soda (NaOH).

16. Process according to claim 9, wherein after step (C) a further compound (vi) is added, which is preferably a polyamine compound capable of making a chain extension of the remaining isocyanate end-groups of the polymer

17. Process according to claim 9, wherein the unsaturated compound (iv) is a non irritation-inducing compound, preferably ditrimethylolpropane triacrylate.

18. Method of preparing a radiation-curable composition which compositoin comprises an aqueous dispersion containing at least one polyurethane polymer, said method comprising reacting tetramethylxylene diisocyanate.
